(19) United States
(12) Patent Application Publication
(10) Pub. No.: US 2006/0239241 A1
(43) Pub. Date: Oct. 26, 2006

(54) Apparatus and method for bandwidth requesting in wireless communication system

(75) Inventors: Kwang-Seop Eom, Sungnam-si (KR); Seol-Hyun Noh, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/409,149

(22) Filed: Apr. 21, 2006

(30) Foreign Application Priority Data
Apr. 21, 2005 (KR) 2005-0032952

(51) Int. Cl. H04B 7/212

(52) U.S. Cl. 370/348

(57) ABSTRACT

Provided are an apparatus and a method for bandwidth requesting apparatus in a subscriber station in a broadcasting wireless communication system. The method includes checking whether there is an incomplete bandwidth request process, checking whether ranging allocation message with respect to a previous bandwidth request is received if there is the incomplete bandwidth request process and transmitting a bandwidth request code with respect to the new bandwidth request if the ranging allocation message with respect to the previous bandwidth request is received. Accordingly, because the new bandwidth request can be initiated even when the previous bandwidth request process is not terminated, the waste of the uplink resource can be prevented and the throughput of the subscriber station can be improved.

### PRIORITY

This application claims priority under 35 U.S.C. § 119 to an application entitled “Apparatus And Method For Bandwidth Requesting In Wireless Communication System” filed in the Korean Intellectual Property Office on Apr. 21, 2005 and allocated Serial No. 2005-32952, the contents of which are incorporated herein by reference.

### BACKGROUND OF THE INVENTION

1. Field of the Invention

The present invention relates generally to a bandwidth requesting apparatus and method in a contention-based system, and in particular, to a bandwidth requesting apparatus and method for increasing data throughput in a broadband wireless communication system.

2. Description of the Related Art

In recent years, an Orthogonal Frequency Division Multiplexing (OFDM)/Orthogonal Frequency Division Multiple Access (OFDMA) scheme has been proposed as a physical layer of a 4^{th} generation (4G) wireless communication system. The OFDM/OFDMA scheme was adopted in the Institute of Electrical and Electronics Engineers (IEEE) 802.16 standard. In the OFDMIOFDMA scheme, serially-inputted modulated symbols are transferred in parallel data format by Inverse Fast Fourier Transform (IFFT). The OFDM/OFDMA scheme may use Frequency Division Duplexing (FDD) and Time Division Duplexing (FDD).

The IEEE 802.16 system operates a ranging channel as a random access channel (RACH) of an uplink. Generally, the RACH is used for an uplink bandwidth request.

Methods of allocating uplink bandwidth in the IEEE 802.16 system differ according to scheduling types based on connections used by terminals. Below is a list of some of these connections used by terminals. A method of allocating the uplink bandwidth according to the connections is also described below.

1) Unsolicited Grant Service (UGS) connection: A subscriber station (SS) does not require a bandwidth request. In establishing a connection, a base station (BS) allocates an uplink bandwidth such that the subscriber station (SS) can transmit data with predetermined size at every UGS interval negotiated via Dynamic Service Add (DSA)-REQ/RSP/ACK message.

2) real-time Polling Service (rtPS) connection: The subscriber station (SS) requests a bandwidth through a bandwidth request header without a ranging process using a bandwidth request code. In establishing a connection, the base station (BS) allocates an uplink bandwidth at which a bandwidth request header can be transmitted at every real-time polling interval negotiated via DSA-REQ/RSP/ACK message.

3) non-real-time Polling Service (ntrPS) connection: The subscriber station (SS) requests a bandwidth through a bandwidth request header without a ranging process using a bandwidth request code. Unlike the rtPS connection, the polling interval is not negotiated via Media Access Control (MAC) message, but the uplink bandwidth at which the bandwidth request header can be transmitted at every period set by the base station (BS) is allocated.

4) Best Effort (BE) service connection: Through a ranging process using a bandwidth request code, the subscriber station (SS) is allocated an uplink bandwidth at which a bandwidth request header is to be transmitted.

Among the above bandwidth allocation methods, the bandwidth allocation method using the BE service connection will be described in more detail.

FIG. 1 is a flowchart illustrating the uplink bandwidth request process in a conventional broadband wireless communication system.

Referring to FIG. 1, in step 101, when data to be transmitted with respect to the service connection is generated, the subscriber station (SS) transmits a bandwidth request code to a bandwidth request ranging area (time-frequency domain). The subscriber station (SS) analyzes UL (uplink)-MAP of each frame and checks whether there exists a ranging allocation message (CDMA (Code Division Multiple Access) allocation UL-MAP information element (IE) with respect to the transmitted bandwidth request code.

In step 103, the base station (BS) that detects the bandwidth request code transmits the UL-MAP containing the ranging allocation message. The ranging allocation message includes bandwidth allocation information for the bandwidth request header of the subscriber station (SS). If the ranging allocation message for the transmitted bandwidth request code is not received during a contention-based reservation timeout, the subscriber station (SS) determines that the ranging fails due to collision of the bandwidth request code and thus performs a retrial using an exponential backoff algorithm.

In step 105, if the ranging allocation message for the transmitted bandwidth request code is received before the contention-based reservation timeout, the subscriber station (SS) transmits the bandwidth request header to the area allocated from the base station (BS). The bandwidth request header includes an identification (ID) information of the subscriber station (SS) and a bandwidth size (amount of data) to be requested.

In step 107, the base station (BS) that receives the bandwidth request header transmits UL-MAP containing a data grant message (data grant E) that grants data transmission of the subscriber station (SS). Then, in step 109, the subscriber station (SS) analyzes the UL-MAP, checks whether or not there is an area allocated with its own connection ID (CID), and transmits uplink data to the allocated area. If there is more data to be transmitted, the above procedures are repeated. As illustrated in FIG. 1, it takes about 40 ms for the subscriber station (SS) to transmit an actual data from the bandwidth request code.

As illustrated in FIG. 1, the conventional bandwidth requesting method does not perform a new bandwidth request until completion of a previous bandwidth request process. When an amount of data to be transmitted by the subscriber station (SS) is larger than a maximum bandwidth (an amount of data) that can be obtained through one bandwidth request, the conventional bandwidth requesting method degrades the uplink throughput of the subscriber station (SS) and wastes the available uplink resources.

FIG. 2 illustrates the conventional bandwidth request process with respect to time.

Referring to FIG. 2, when the subscriber station (SS) transmits the bandwidth request code at an uplink interval of a k^{th} frame, the base station (SS) transmits the ranging allocation message (CDMA allocation IE) at a downlink interval of a (k+2)^{th} frame. The subscriber station (SS) that receives the ranging allocation message transmits a bandwidth request header to the allocated area at an uplink interval of a (k+3)^{th} frame. The bandwidth request header includes an ID information of the subscriber station (SS) and a bandwidth size to be requested. Meanwhile, the base station (BS) that receives the bandwidth request header transmits the data grant message (data grant IE) that grants data transmission of the subscriber station (SS) at a downlink interval of a (k+6)^{th} frame. The subscriber station (SS) that receives the data, grant message transmits an uplink data to an allocated area at a (k+7)^{th} frame. Assuming that one frame interval is 5 ms, it takes about 40 ms to transmit an actual data since the subscriber station (SS) transmits the bandwidth request code. If an amount of data to be transmitted is larger than a maximum bandwidth that can acquire one-time bandwidth request process, the method of transmitting the uplink data at every 40 ms degrades the uplink throughput of the subscriber station (SS) and wastes the available uplink resources.

For example, the maximum throughput that can be allocated to one subscriber station (SS) by the bandwidth requesting method of FIG. 1 is 168 Kbps, when the modulation and coding rate used when the subscriber station (SS) transmits the uplink data are Quadrature Phase Shift Keying (QPSK) and ½, respectively, and Partial Usage of SubCarrier is used as a permutation scheme of the uplink data region. This is because the uplink data can be transmitted one time at every 40 ms. If the uplink data can be transmitted at every frame (5 ms), the maximum throughput of the subscriber station (SS) is 1344 Kbps (168 Kbps×8).

As described above, the conventional bandwidth requesting method cannot perform a new bandwidth request before completion of a current bandwidth request process. Consequently, the uplink throughput of the subscriber station (SS) is degraded and the resources are wasted.

### SUMMARY OF THE INVENTION

An object of the present invention is to substantially solve at least the above problems and/or disadvantages and to provide at least the advantages below. Accordingly, an object of the present invention is to provide an apparatus and method for performing a new bandwidth request regardless of the completion of a previous bandwidth request process in a wireless communication system.

Another object of the present invention is to provide an apparatus and method for performing a new bandwidth request regardless of the completion of a previous bandwidth request process in a contention-based system.

A further object of the present invention is to provide an apparatus and method for performing a plurality of bandwidth request processes concurrently in a contention-based system.

Another further object of the present invention is to provide an apparatus and method for performing an uplink bandwidth request with respect to a BE (Best Effort) service connection in a broadband wireless communication system.

Still another further object of the present invention is to provide an apparatus and method for performing a plurality of bandwidth request processes concurrently with respect to one service connection.

According to one aspect of the present invention, a bandwidth requesting method of a subscriber station in a wireless communication system includes when a new bandwidth request with respect to a predetermined service connection is generated, checking whether a bandwidth request process is completed; when the bandwidth request process is uncompleted, checking whether ranging allocation message with respect to a previous bandwidth request is received; and when the ranging allocation message with respect to the previous bandwidth request is received, transmitting a bandwidth request code with respect to the new bandwidth request.

According to another aspect of the present invention, a subscriber station of a broadband wireless communication system includes a scheduler for checking whether a ranging allocation message is received from a base station in response to a previous bandwidth request when a new bandwidth request is generated, and controlling a MAC block to initiate the new bandwidth request process when the ranging allocation message is received; the MAC block for generating a bandwidth request code with respect to the new bandwidth request under control of the scheduler; and a transmission modem for mapping the bandwidth request code received from the MAC block into a predetermined ranging region.

### BRIEF DESCRIPTION OF THE DRAWINGS

The above and other objects, features and advantages of the present invention will become more apparent from the following detailed description when taken in conjunction with the accompanying drawings in which:

FIG. 1 is a flowchart illustrating an uplink bandwidth allocation process in a conventional broadband wireless communication system;

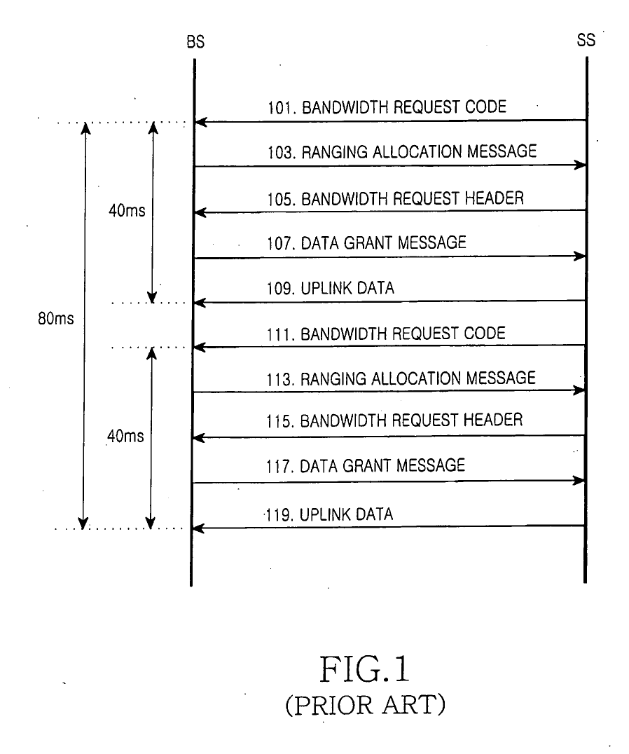

FIG. 2 illustrates the conventional bandwidth request process with respect to time;

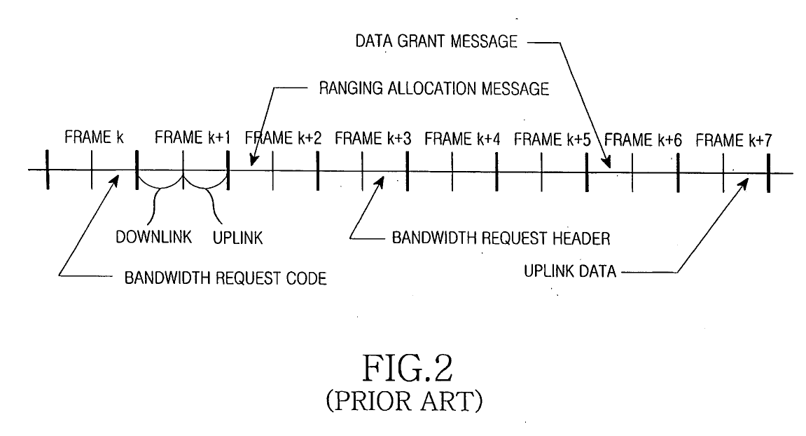

FIG. 3 is a block diagram schematically illustrating a subscriber station (SS) in an OFDMA wireless communication system according to the present invention;

FIG. 4 is a flowchart illustrating an uplink bandwidth request process of a subscriber station in the OFDMA wireless communication system according to the present invention;

FIG. 5 illustrates messages exchanged between a base station and a subscriber station in the OFDMA wireless communication system according to the present invention; and

FIG. 6 illustrates the bandwidth request process with respect to time according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

A following description is of a method that can perform a new bandwidth request regardless of termination of a previous bandwidth request process in a contention-based system. A bandwidth request process for a BE service connection in a broadband wireless communication system (e.g., an IEEE 802.16 system) will be taken as an example.

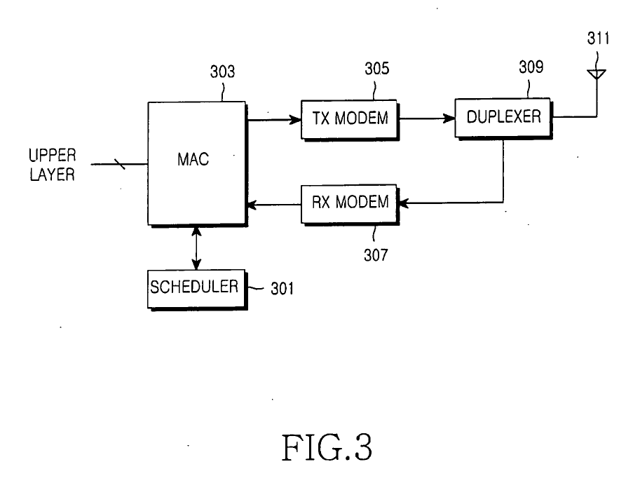

FIG. 3 is a block diagram schematically illustrating a subscriber station (SS) in an OFDMA wireless communication system according to the present invention. The subscriber station (SS) manages N number of bandwidth request state machines for one BE service connection, where 1≦N<bandwidth request processing delay (frames).

Referring to FIG. 3, the subscriber station (SS) includes a scheduler 301, a MAC block 303 connected to an upper layer, a transmission (TX) modem 305, a reception (RX) modem 307, a duplexer 309, and an antenna 311.

The MAC block 303 processes TX data received from the upper layer based on the interface with the TX modem 305, and then transmits the processed TX data to the TX modem 305. Also, the MAC block 303 processes RX data received from the RX modem 307 based on the interface with the upper layer, and then transmits the processed RX data to the upper layer.

The TX modem 305 includes a channel coding block, a modulation block, and an RF transmission block. The TX modem 305 converts the data from the MAC block 303 into a format for wireless interval transmission and transmits the converted data to the duplexer 309. The channel coding block includes a channel encoder, an interleaver, and a modulator. The modulation block includes an Inverse Fast Fourier Transform (IFFT) for loading the TX data on a plurality of orthogonal subcarriers. The RF transmission block may include a filter and an RF front-end unit.

The RX modem 307 includes an RF reception block, a demodulation bock, and a channel decoding block. The RX modem 307 decodes data from wireless interval signals received from the duplexer 309, and transmits the decoded data to the MAC block 303. The RF reception block includes a filter and an RF front-end unit. The demodulation block includes a Fast Fourier Transform (FFT) operator. The channel decoding block may include a demodulator, a deinterleaver, and a channel decoder.

The duplexer 309 transmits the received signal (downlink signal) from the antenna 311 to the RX modem 307 according to a TDD scheme, and transmits the TX signal (uplink signal) from the TX modem 305 to the antenna 311.

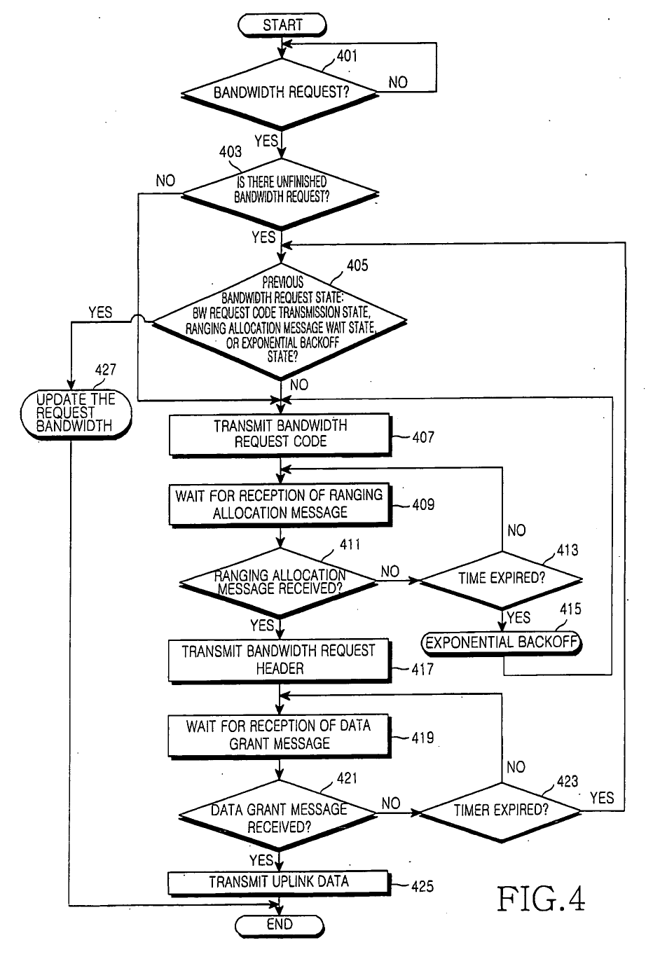

The scheduler 301 receives the downlink from the base station (BS) according to the received UL/DL-MAP information and controls the MAC block 303 to allow the transmission of the uplink frame. Also, the scheduler 301 controls the MAC block 303 to allow execution of the bandwidth request process. An operation of the scheduler 301 will be described in detail below with reference to FIG. 4. FIG. 4 is a flowchart illustrating the uplink bandwidth request process of the subscriber station in the OFDMA wireless communication system according to the present invention.

Referring to FIG. 4, in step 401, the scheduler 301 checks whether data to be transmitted to the service connection (e.g., BE connection) is generated. That is, the scheduler 301 checks whether a new bandwidth request is generated. If the new bandwidth request is generated, the scheduler 301 checks in step 403 whether or not there is an incompleted bandwidth request process.

If there is no completed bandwidth request process, the scheduler 301 proceeds to step 407. In step 405, if there is the incompleted bandwidth request process, the scheduler 301 checks whether the state of the previous bandwidth request process is in a bandwidth request code transmission state, a ranging allocation message wait state, or an exponential backoff state.

In step 427, if the previous bandwidth request process is in one of the three above-mentioned states, the scheduler 301 adds a request bandwidth size (amount of data) of the new bandwidth request to a request bandwidth size (amount of data) of the previous bandwidth request and terminates this algorithm. That is, step 427 is to check whether the ranging allocation message is received from the base station (BS) with respect to the previous bandwidth request process. If the ranging allocation message is not received, the scheduler 301 updates the request bandwidth and again issues the bandwidth request in step 427.

If the previous bandwidth request process is not in any one of the three states, that is, if the ranging allocation message is received from the base station (BS) with respect to the previous bandwidth request process, the scheduler 301 transmits the bandwidth request code to the ranging region corresponding to the new bandwidth request in step 407. In step 409, the scheduler 301 waits for the reception of the ranging allocation message (CDMA allocation IE). In step 411, upon the reception of the MAP information, the scheduler 301 analyzes the received MAP information and checks whether or not the ranging allocation message for the subscriber station (SS) exists.

In step 413, if the ranging allocation message is not received, the scheduler checks whether the contention-based reservation timer is expired. If the timer is not expired, the process returns to step 409. Otherwise, if the timer is expired, the scheduler 301 performs an exponential backoff in step 415 and returns to step 407 to repeat the bandwidth request. The exponential backoff is one of operations for calculating a delay time taken until the bandwidth request is repeated when the collision occurs in the contention-based system.

In step 417, if the ranging allocation message is received, the scheduler 301 transmits the bandwidth request header to the region designated in the ranging allocation message. The bandwidth request header includes the ID information of the subscriber station (SS) and the bandwidth size (amount of data) to be requested.

In step 419, after the bandwidth request header is transmitted, the scheduler 301 waits for the reception of the data grant message (data grant IE). In step 421, upon the reception of the MAP information, the scheduler 301 analyzes the MAP information and checks whether there is the data grant message for the subscriber station (SS).

In step 423, if the data grant message is not received, the scheduler 301 checks whether the bandwidth grant timer is expired. If the timer has not expired, the process returns to step 419. Otherwise, if the timer is expired, the process returns to step 405.

If the data grant message is received, the scheduler 301 transmits the uplink data to the region designated in the data grant message in step 425 and then terminates this algorithm.

As described above, a plurality of bandwidth request process can be performed concurrently. The state of the previous bandwidth request process is determined when the new bandwidth request is generated. At this point, the previous bandwidth request process is in one of the bandwidth request code transmission state, the ranging allocation message wait (CDMA allocation E wait) state, and the exponential backoff state, the bandwidth size of the previous bandwidth request and the bandwidth size of the new bandwidth request are added and the bandwidth request is attempted. If the previous bandwidth request process is not in any one of the three states, the bandwidth request code is transmitted and the bandwidth request is initiated.

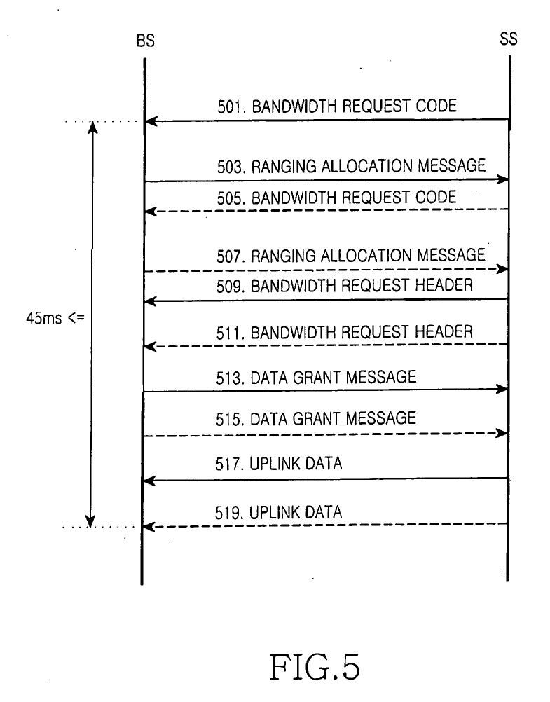

FIG. 5 illustrates messages exchanged between the base station and the subscriber station in the OFDMA wireless communication system according to the present invention.

Referring to FIG. 5, in step 501, if the data to be transmitted with respect to the service connection is generated, the subscriber station (SS) transmits the bandwidth request code to the bandwidth request ranging region. Then, the subscriber station (SS) analyzes the UL-MAP of each frame and checks whether the ranging allocation message (CDMA allocation UL-MAP IE) for the transmitted bandwidth request code exists.

In step 503, the base station (BS) that receives the bandwidth request code transmits the UL-MPA containing the ranging allocation message. If the ranging allocation message for the transmitted bandwidth request code is not received while the contention-based reservation timer has expired, the subscriber station (SS) determines that the ranging fails due to the collision of the bandwidth request code and performs a retrial using the exponential backoff algorithm.

If the ranging allocation message for the transmitted bandwidth request code is received before the contention-based reservation timer is expired, the subscriber station (SS) transmits the bandwidth request header to the region allocated from the base station (BS) in step 509. The bandwidth request header includes the ID information of the subscriber station (SS) and the bandwidth size (amount of data) to be requested.

In step 513, the base station (BS) that receives the bandwidth request header transmits the UL-MAP containing the data grant message (data grant IE) that grants the data transmission of the subscriber station (SS). In step 517, the subscriber station (SS) analyzes the UL-MAP and checks whether the data grant message exists, and transmits the uplink data to the region designated in the data grant message.

Meanwhile, if the new bandwidth request is generated in a state that the ranging allocation message for the previous bandwidth request is received in step 503, the subscriber station (SS) transmits the bandwidth request code to the bandwidth request ranging region regardless of the completion of the previous bandwidth request process. The base station (BS) that receives the bandwidth request code transmits the ranging allocation message in step 507, and transmits the bandwidth request header to the region designated in the ranging allocation message in step 511. The base station (BS) that receives the bandwidth request header transmits the data grant message that grants the data transmission of the subscriber station (SS) in step 515, and transmits the uplink data to the region designated in the data grant message in step 519.

As illustrated in FIG. 5, if the new bandwidth request is performed before the previous bandwidth request is completed, the subscriber station (SS) can transmit two times the uplink data for about 45 ms. Therefore, the uplink throughput of the subscriber station (SS) can be improved and the waste of the bandwidth can be prevented.

For the understanding of the present invention more fully, the formats of the messages will be described below.

Table 1 below shows the formats of the UL-MAP information element (IE).

TABLE 1

| Syntax | Size | | Notes |
|---|---|---|---|
| UL-MAP IE( ){ | | | |
| CID | 16 | bits | |
| UIUC | 4 | bits | |
| If(UIUC==12){ | | | |
| OFDMA Symbol offset | 8 | bits | |
| Subchannel offset | 7 | bits | |
| No. OFDMA Symbols | 7 | bits | |
| No. Subchannels | 7 | bits | |
| Ranging Method | 2 | bits | 0b00: Initial Ranging over two |
| | | | symbols |
| | | | 0b01: Initial Ranging over four |
| | | | symbols |
| | | | 0b10: BW Request Periodic |
| | | | Ranging over one symbol |
| | | | 0b11: BW Request Periodic |
| | | | Ranging over three symbols |
| Reserved | 1 | bits | Shall be set to zero |
| }else if(UIUC==4){ | | | |
| CDMA_Allocation_IE( ) | 32 | bits | |
| }else if(UIUC==15)P | | | |
| Extended UIUC | Variable | | |
| dependent IE | | | |
| }else{ | | | |
| Duration | 10 | bits0 | In OFDMA slots |
| Repetition coding | 2 | bits | 0b00: No Repetition |
| indication | | | 0b01: Repetition coding 2 used |
| | | | 0b10: Repetition coding 4 used |
| | | | 0b11: Repetition coding 6 used |
| } | | | |
| Padding nibble, if needed | 4 | bits | Completing to nearest byte, shall |
| | | | be set to 0 |

As can be seen from Table 1, the UL-MAP IE includes Connection ID (CID), Uplink Interval Usage Code (UIUC), Duration, and Repetition coding indication information. The UL-MAP IE including information for allocating uplink data burst is defined as the data grant IE. Since the uplink data burst is allocated in one-dimension way, the subscriber station (SS) analyzes the UL-MAP and finds the starting point at which the data can be transmitted. Then, the subscriber station (SS) transmits the uplink data using the region (or resource) corresponding to the duration from the starting point.

Meanwhile, the UL-MAP IE may include the information for the ranging (OFDMA symbol offset, Subchannel offset, number of OFDMA symbols, number of subchannels, and ranging method) according to the UIUC values, may include the ranging allocation message (CDMA_Allocation_IE), or may include the extended UIUC dependent IE.

When the UIUC value is 14, the UL-MAP IE includes the ranging allocation message (CDMA_Allocation_IE) such as information of Table 2 below.

TABLE 2

| Syntax | Size | | Notes |
|---|---|---|---|
| CDMA allocation IE( ){ | | | |
| Duration | 6 | bits | duration of allocation (unit: |
| | | | OFDMA slot) |
| Repetition Coding | 2 | bits | 0b00: NO Repetition |
| Indication | | | 0b01: Repetition coding 2 used |
| | | | 0b10: Repetition coding 4 used |
| | | | 0b11: Repetition coding 6 used |
| Ranging Code | 8 | bits | the CDMA Code sent by the SS |
| Ranging Symbol | 8 | bits | the OFDMA symbol used by the |
| | | | SS |
| Ranging Subchannel | 7 | bits | the Ranging subchannel used by |
| | | | the SS to send the CDMA code |
| BW Request Mandatory | 1 | bit | indicates whether the SS shall |
| | | | include a BW request in the |
| | | | allocation |
| } | | | |

As can be seen from Table 2, the ranging allocation message includes the duration information, the repetition coding indication information, the ranging code information sent by the subscriber station (SS), the ranging symbol information and the ranging subchannel information allocated to the subscriber station (SS), and the bandwidth request mandatory information. When the subscriber station (SS) receives the ranging allocation message, it transmits the bandwidth request header to the region designated by the ranging symbol information and the subchannel information.

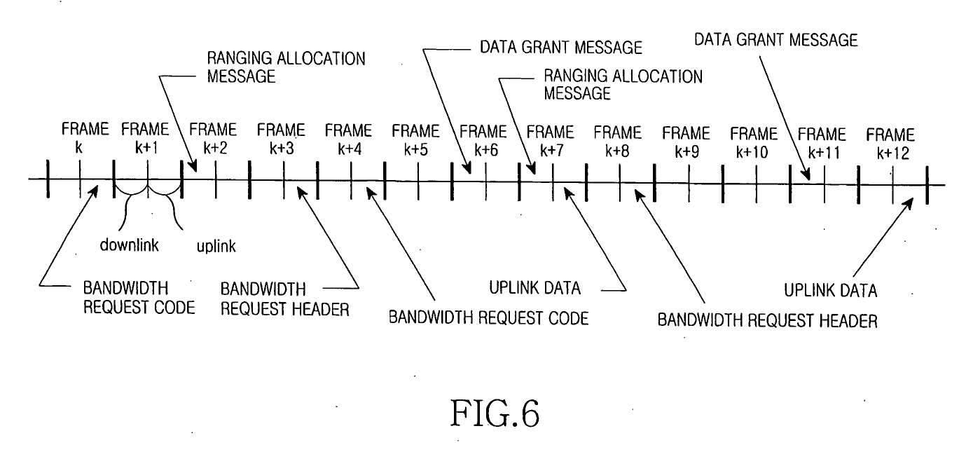

FIG. 6 illustrates the bandwidth request process with respect to time according to the present invention.

Referring to FIG. 6, if the subscriber station (SS) transmits the bandwidth request code at the uplink interval of the k^{th} frame, the base station (BS) transmits the ranging allocation message (CDMA Allocation IE) at the downlink interval of the (k+2)^{th} frame. The subscriber station (SS) that receives the ranging allocation message transmits the bandwidth request header to the region allocated from the base station (BS) at the uplink interval of the (k+3)^{th} frame. The bandwidth request header includes the ID information of the subscriber station (SS) and the information on the amount of data to be transmitted.

If a new bandwidth request is generated after the ranging allocation message is received, the subscriber station (SS) transmits the bandwidth request code corresponding to the new bandwidth request at the uplink interval of the (k+4)^{th} frame regardless of the completion of the previous bandwidth request.

Meanwhile, the base station (BS) that receives the bandwidth request header with respect to the previous bandwidth request transmits the data grant message (data grant IE) containing the resource information to be allocated to the subscriber station (SS) at the downlink interval of the (k+6)^{th} frame. The subscriber station (SS) that receives the data grant message transmits the uplink data to the region allocated in the uplink interval of the (k+7)^{th} frame.

Also, the base station (BS) that receives the bandwidth request code with respect to the new bandwidth request transmits the ranging allocation message at the downlink interval of the (k+7)^{th} frame. The subscriber station (SS) that receives the ranging allocation message transmits the bandwidth request header at the uplink interval of the (k+8)^{th} frame, and the base station (BS) transmits the data grant message at the downlink interval of the (k+11)^{th} frame in response to the bandwidth request header. The subscriber station (SS) that receives the data grant message transmits the uplink data with respect to the new bandwidth request at the uplink interval of the (k+12)^{th} frame.

Assuming that one frame interval is 5 ms, it takes about 40 ms for the subscriber station to actually transmit the data from the transmission of the bandwidth request code. According to the prior art, the new bandwidth request cannot be performed until one bandwidth request is completed. Therefore, the bandwidth of only two frames can be used to actually transmit the uplink data during 16 frames. Consequently, the throughput is a mere 168 Kbps. On the contrary, because the present invention can use the bandwidth of the maximum 8 frames during 16 frames, the throughput can be increased up to 672 Kbps.

As described above, because the new bandwidth request can be initiated even when the previous bandwidth request process is incompleted, the opportunity for the uplink data transmission of the subscriber station (SS) can be increased. That is, the prevent invention can prevent the waste of the uplink resources and improve the throughput of the subscriber station (SS).

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A bandwidth requesting method of a subscriber station in a contention based communication system, comprising:
checking whether a ranging allocation message with respect to a previous bandwidth request is received from a base station; and
initiating a new bandwidth request process when the ranging allocation message is received.

2. The bandwidth requesting method of claim 1, further comprising, when the ranging allocation message with respect to the previous bandwidth request is not received, adding a request bandwidth size of the previous bandwidth request to a request bandwidth size of the new bandwidth request and regenerating the bandwidth request.

3. The bandwidth requesting method of claim 1, wherein the subscriber station manages at least one bandwidth request state machine with respect to a predetermined service connection.

4. The bandwidth requesting method of claim 3, wherein the service connection is a BE (Best Effort) service connection.

5. A bandwidth requesting method of a subscriber station in a wireless communication system, comprising:
checking whether there is an incomplete bandwidth request process when a new bandwidth request with respect to a predetermined service connection is generated;
checking whether a ranging allocation message with respect to a previous bandwidth request is received when there is the incomplete bandwidth request process; and
transmitting a bandwidth request code with respect to the new bandwidth request when the ranging allocation message with respect to the previous bandwidth request is received.

6. The bandwidth requesting method of claim 5, further comprising, when the ranging allocation message with respect to the previous bandwidth request is not received, adding a request bandwidth size of the previous bandwidth request to a request bandwidth size of the new bandwidth request and regenerating the bandwidth request.

7. The bandwidth requesting method of claim 5, wherein the subscriber station manages at least one bandwidth request state machine with respect to the service connection.

8. The bandwidth requesting method of claim 7, wherein the service connection is a BE (Best Effort) service connection.

9. The bandwidth requesting method of claim 5, further comprising:
after the bandwidth request code is transmitted, checking whether the ranging allocation message is received from abase station; and
transmitting a bandwidth request header, which contains a bandwidth size to be requested, to a region designated in the ranging allocation message when the ranging allocation message is received.

10. The bandwidth requesting method of claim 9, further comprising re-transmitting the bandwidth request code based on an exponential backoff, when the ranging allocation message is not received within a predetermined time after the bandwidth request code is transmitted.

11. The bandwidth requesting method of claim 9, further comprising:
after the bandwidth request header is transmitted, checking whether a resource allocation message is received from the base station; and
transmitting an uplink data to a region designated in the resource allocation message when the resource allocation message is received.

12. A subscriber station of a wireless communication system, comprising:
a scheduler for checking whether a ranging allocation message is received from a base station in response to a previous bandwidth request when a resource allocation message is received, and controlling a MAC block to initiate a new bandwidth request process when the ranging allocation message is received;
the MAC block for generating a bandwidth request code with respect to the new bandwidth request under control of the scheduler; and
a transmission modem for mapping the bandwidth request code received from the MAC block into a ranging region.

13. The subscriber station of claim 12, wherein when the ranging allocation message with respect to the previous bandwidth request is not requested, the scheduler adds a request bandwidth size of the previous bandwidth request to a request bandwidth size of the new bandwidth request and regenerates the bandwidth request.

14. The subscriber station of claim 12, wherein when the ranging allocation message is received from the base station with respect to the bandwidth request code, the MAC block generates a bandwidth request header containing a bandwidth size to be requested and transmits the generated bandwidth request header to the transmission modem.

15. The subscriber station of claim 12, wherein the scheduler manages at least one bandwidth request state machine with respect to a service connection.

16. The subscriber station of claim 12, wherein a service connection is a BE (Best Effort) service connection.

17. A bandwidth requesting method of a subscriber station in a wireless communication system, comprising:
checking whether a ranging allocation message with respect to a previous bandwidth request is received from the subscriber station; and
initiating a new bandwidth request process if the ranging allocation message is received.

18. A bandwidth requesting method of a subscriber station in a wireless communication system, comprising:
checking whether there is an incomplete bandwidth request process;
checking whether a ranging allocation message with respect to a previous bandwidth request is received if there is the incomplete bandwidth request process; and
transmitting a bandwidth request code with respect to the new bandwidth request if the ranging allocation message with respect to the previous bandwidth request is received.

19. A subscriber station of a wireless communication system, comprising:
a scheduler for checking a reception of a ranging allocation message from a base station, and controlling a MAC block to initiate the new bandwidth request process if the ranging allocation message is received;
the MAC block for generating a bandwidth request code with respect to a new bandwidth request under control of the scheduler; and
a transmission modem for mapping the bandwidth request code received from the MAC block into a ranging region.

20. The subscriber station of claim 19, wherein the scheduler manages at least one bandwidth request state machine with respect to a service connection.
